(19) United States
(12) Patent Application Publication
(10) Pub. No.: US 2024/0425990 A1
(43) Pub. Date: Dec. 26, 2024

(54) CORROSION INHIBITORS FOR COPPER AND OTHER YELLOW METALS AND METHODS OF USING SAME

(71) Applicant: Solugen, Inc., Houston, TX (US)

(72) Inventors: Jun Su An, Houston, TX (US); Chris Arceo, Richmond, TX (US); Darlen Galicia, Houston, TX (US); Donald A. Johnson, Batavia, IL (US); LoongYi Tan, Houston, TX (US); Frederyk Ngantung, Houston, TX (US)

(73) Assignee: Solugen, Inc., Houston, TX (US)

(21) Appl. No.: 18/575,110

(22) PCT Filed: Jul. 26, 2022
(86) PCT No.: PCT/US2022/074127

§ 371 Date: Dec. 28, 2023

Related U.S. Application Data
(60) Provisional application No. 63/225,752, filed on Jul. 26, 2021.

(51) Int. Cl. C23F 11/14

(52) U.S. Cl. CPC C23F 11/148

(57) ABSTRACT

A corrosion inhibitor for a surface comprising copper or alloys thereof. The corrosion inhibitor may comprise a biochelant, a primary corrosion inhibitor, and a solvent.

### CROSS-REFERENCE TO RELATED APPLICATIONS

This application is a 35 U.S.C. § 371 national stage application of PCT/US2022/074127 filed Jul. 26, 2022 and entitled “Corrosion Inhibitors for Copper and Other Yellow Metals and Methods of Using Same,” which claims priority to U.S. Provisional Application Ser. No. 63/225,752 filed Jul. 26, 2021 and entitled “Corrosion Inhibitors for Copper and Other Yellow Metals and Methods of Using Same,” each of which is incorporated herein by reference in its entirety for all purposes.

### FIELD

The present disclosure relates generally to materials and compositions for use in corrosion inhibition. More particularly, this disclosure relates to compositions for the protection of the integrity of surfaces comprising copper, brass, other yellow metals or combinations thereof.

### BACKGROUND

Copper with a reddish orange color is the fifth most usual metal in the earth's crust. Nonetheless, copper is very useful in both its pure or alloy forms. Brass, copper-nickel, and bronze are all particularly important copper alloys. Copper and its alloys are widely used in industries because of some favorable properties such as good corrosion resistance, high electrical and thermal conductivity, mechanical workability, and malleability.

Copper and its alloys are highly regarded because of their wide application in production of wire, sheets, and pipelines in electronic industries, marine industries, power stations, heat exchangers, boilers, and cooling towers. They are also used in various other parts such as valves and impellers, which will come into contact with the process fluid or industrial water.

Copper is a noble metal which provides some corrosion resistance under atmospheric conditions and in some of chemical environments due to the formation of a protective, passive (oxide) film or nonconductive layer of corrosion products on its surface. However, depending on the environmental conditions, pitting of the corrosion layer may occur on the copper surface in the presence of oxygen and some aggressive anions such as chloride and sulfate ions. The corrosion of copper and the formation of corrosion products on its surface can have a negative effect on the performance of a system or component constructed from copper and may reduce its efficiency. Furthermore, free copper can lead to localized galvanic corrosion, as copper precipitates onto carbon steel.

As such, given the widespread use and importance of copper in various applications across many industries, inhibition of corrosion on surfaces including is relevant.

### BRIEF SUMMARY

In some aspects, a corrosion inhibitor for a surface comprising copper or alloys thereof comprises a biochelant, a primary corrosion inhibitor, and a solvent. The biochelant may be a naturally-occurring molecule or derived from a monosaccharide or a polysaccharide. For example, the biochelant may comprise aldonic acid, uronic acid, aldaric acid, a salt thereof, a derivative thereof, or combinations thereof. The biochelant may comprise sodium gluconate, an oxidation product of sodium glucarate, one or more salts thereof, one or more derivatives thereof, or combinations thereof. The biochelant may further comprise n-keto acids and C₂-C₆ diacids in amounts of less than about 50 wt. %. The primary corrosion inhibitor may comprise a thiazole, a triazole or combinations thereof. For example, the primary corrosion inhibitor may comprise imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazole, tolytriazole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, derivatives thereof, or combinations thereof. The solvent comprises ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or combinations thereof. The solvent may comprise methanol, ethanol, propanol, isopropanol, n-butanol, isobutanol, pentanol, hexanol, heptanol, octanol, benzyl alcohol, phenol, cyclohexanol, and the like, and combinations thereof. The biochelant may be a mixture of aldaric, uronic acids. The biochelant may be a mixture of aldaric acid, uronic acid, and their respective counter-cation. For example, the biochelant may comprise glucaric acid, gluconic acid, glucuronic acid, glucose oxidation products, and gluconic acid oxidation products. Additionally or alternatively, the biochelant may comprise sugar oxidation products comprising disaccharides, oxidized disaccharides, uronic acid, and aldaric acid. For example, the biochelant may comprise gluconic acid, glucaric acid, glucuronic acid, n-keto-acids and C2-C6 diacids. The counter-cation comprises an alkali earth metal of group 1 and group 2. For example, the counter-cation may comprise a rare earth metal. Additionally or alternatively, the counter-cation comprises ammonium.

Additionally or alternatively, in some aspects, a method for reducing corrosion in a system comprising copper, brass, other yellow metals, alloys thereof, or combinations thereof. The method may comprise introducing an aqueous solution comprising the corrosion inhibitor of. The system may comprise industrial water. The industrial water may further comprise soluble copper, halides, or both.

### BRIEF DESCRIPTION OF DRAWINGS

For a detailed description of the aspects of the disclosed processes and systems, reference will now be made to the accompanying drawings in which:

FIG. 1 depicts a graph of conductivity as a function of sample composition for the samples from Example 1.

FIG. 2 depicts a graph of conductivity as a function of sample composition for the samples from Example 2.

FIG. 3 depicts a graph of conductivity as a function of sample composition for the samples from Example 3.

### DETAILED DESCRIPTION

Disclosed herein are compositions and methods for reducing the corrosion of surfaces comprising copper, more particularly, copper and alloys thereof, for example, “yellow” metals such as brass or bronze, or combinations thereof, for instance, which may be exposed to aqueous system. Hereinafter, for simplicity copper, brass, other yellow metals, alloys thereof, or combinations thereof are collectively referred to as copper and copper-like metals and designated CUL.

In an aspect, the compositions disclosed herein may be effective to reduce the amount of deposition of a material onto a surface of a component and/or to chemically alter the surface, either of which may be detrimental to the component (e.g., equipment) and/or process utilizing the component. In an aspect, the surface of the equipment comprises copper and alloys thereof, for example, a yellow metal (e.g., brass, bronze).

In an aspect, the aqueous system to which the CUL comprises industrial water. Herein, “industrial water” refers to water used in an industrial operation such as fabricating, processing, washing, diluting, cooling, or transporting a product; incorporating water into a product; or for sanitation needs. In an aspect, the industrial water is a feed water. Herein, a feed water refers to water used in boilers and/or cooling towers to ensure or enhance efficiency, maximize boiler and system life, reduce maintenance costs, maintain levels of operational performance, or the like. In one or more aspects, the industrial water is present in a cooling system such as a once-through cooling system, a closed recirculating cooling system, or dry cooling tower; or an open recirculating system such as a wet cooling tower or evaporative cooling tower. In another aspect, the industrial water facilitates the cooling of an internal combustion engine.

In an aspect, the compositions disclosed herein may improve the functioning of another corrosion inhibitor, for example, a conventional corrosion inhibitor or combination of conventional corrosion inhibitors. As such, compositions of the present disclosure may comprise a primary corrosion inhibitor as a component. Generally, it is to be understood the compositions disclosed herein demonstrate an increased level of corrosion inhibition, for instance, when compared to the primary corrosion inhibitor alone. Hereinafter, such compositions are generally termed CUL surface corrosion inhibitors or CULSCIs.

In an aspect, a CULSCI of the present disclosure generally comprises a biochelant, a solvent, and a primary corrosion inhibitor.

In an aspect, an CULSCI of the present disclosure comprises a chelant, for example, a biochelant. Herein, a chelant, also termed a sequestrant or a chelating agent, refers to a molecule capable of bonding a metal. The chelating agent is a ligand that contains two or more electron-donating groups so that more than one bond forms between each of the atoms on the ligand to the metal. This bond can also be dative or a coordinating covalent bond meaning the electrons from each electronegative atom provides both electrons to form the bond to the metal center. In an aspect, the chelant is a biochelant. As used herein, the prefix “bio” indicates production by a biological process such as using an enzyme catalyst.

In an aspect, the biochelant comprises an aldonic acid, uronic acid, aldaric acid, or combinations thereof; and a counter cation. The counter cation may comprise an alkali metal (Group I), an alkali earth metal (Group II), or combinations thereof. In certain aspects, the counter cation is sodium, potassium, magnesium, calcium, strontium, cesium, or combinations thereof. In the alternative, the counter cation comprises aluminum, silica, titanium, or boron.

In an aspect, the biochelant comprises a glucose oxidation product, a gluconic acid oxidation product, a gluconate, glucaric acid, or combinations thereof. The glucose oxidation product, gluconic acid oxidation product, or the combination thereof is buffered to a suitable pH. Buffering can be carried out using any suitable methodology such as by using a pH adjusting material in an amount of from about 1 weight percent (wt. %) to about 10 wt. %, additionally or alternatively, from about 1 wt. % to about 3 wt. % or, additionally or alternatively, from about 5 wt. % to about 9 wt. % based on the total weight of the biochelant. In an aspect, the biochelant comprises from about 1 wt. % to about 8 wt. % of a caustic solution in a 20 wt. % gluconate solution.

Additionally or alternatively, in some aspects the biochelant comprises a buffered glucose oxidation product, a buffered gluconic acid oxidation product, or combinations thereof. In such aspects, the buffered glucose oxidation product, the buffered gluconic acid oxidation product, or the combination thereof is buffered to a suitable pH such as from about 6 to about 7, using any suitable acid or base such as sodium hydroxide. In such aspects, the biochelant comprises a mixture of gluconic acid and glucaric acid, and further comprises a minor component species comprising n-keto-acids, C2-C6 diacids, or combinations thereof. In an aspect, the biochelant comprises BIOCHELATE™ metal chelation product commercially available from Solugen, Inc. of Houston, Texas.

Additionally or alternatively, the biochelant can also chelate or sequester other monovalent and divalent cations commonly found in industrial waters such as copper, calcium, magnesium, barium, potassium, strontium, boron, cesium, beryllium, and sodium.

In an aspect, the biochelant is present in the CULSCI in an amount of from about 0.1 weight percent (wt. %) to about 70 wt. % based on the total weight of the composition, additionally or alternatively, from about 0.1 wt. % to about 15 wt. %, or additionally or alternatively, from about 0.1 wt. % to about 2.5 wt. %. Herein, the weight percentage is based on the total weight of the indicated composition unless specified otherwise.

In an aspect, the CULSCI of the present disclosure comprises a primary corrosion inhibitor. For example, the primary corrosion inhibitor comprises a thiazole, a triazole, or combinations thereof. Thiazoles and triazoles are five-atom aromatic ring molecules that contain a nitrogen atom and at least one other nitrogen, oxygen, or sulfur atom as part of the ring. The azole-based compounds can be divided into three major classes, namely, nitrogen-containing (N-containing), nitrogen and oxygen-containing (N&O-containing), and nitrogen and sulfur-containing (N&S-containing) azole sets.

In an aspect, the primary corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazole, tolytriazole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, derivatives thereof, or combinations thereof.

In an aspect, the primary corrosion inhibitor is present in the CULSCI in an amount of from about 0.001 wt. % to about 50 wt. %, additionally or alternatively, from about 0.001 wt. % to about 5 wt. %, additionally or alternatively, from about 0.1 wt. % to about 0.3 wt. % or, alternatively from about 5 wt. % to about 50 wt. %.

In an aspect, an CULSCI of the present disclosure further comprises a solvent. In general, any solvent compatible with the CULSCI and/or activity to be undertaken may be utilized. In an aspect, the solvent comprises water, an alcohol, or a polyol. In an aspect, the polyol can be an aliphatic polyol such as ethylene glycol, diethylene glycol, triethylene glycol, tetraethylene glycol, tripropylene glycol, 1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or combinations thereof. Non-limiting examples of suitable alcohols that can be utilized as a solvent include methanol, ethanol, propanol, isopropanol, n-butanol, isobutanol, pentanol, hexanol, heptanol, octanol, benzyl alcohol, phenol, cyclohexanol, and the like, and combinations thereof. In an aspect, the solvent comprises water, methanol, ethanol, ethylene glycol, propylene glycol, or combinations thereof.

In an aspect, the solvent may be present in an amount of from about 10% to about 100% based on the total volume of the composition. In an alternative aspect, solvent may be present in the CULSCI in an amount that constitutes the remainder of the composition once all other components are accounted for.

In one or more aspects, an CULSCI of the type disclosed herein can be prepared using any suitable methodology. For example, the biochelant, primary corrosion inhibitor and solvent may be blended or mixed in a suitable vessel (e.g., container, blender etc.). In some aspects, the components of the CULSCI may be mixed to form a homogenous mixture that can subsequently be introduced to a system to facilitate scale inhibition and/or corrosion inhibition.

In an aspect, the CULSCI or two or more components thereof may be pre-blended prior to addition to a system. For example, the biochelant and conventual corrosion inhibitor, with or without solvent, may be added separately in a pre-treatment scenario.

In one or more aspects, a CULSCI is introduced to a system that utilizes industrial water, such as and without limitation cooling towers, boilers, evaporators, heat exchangers, chillers, reverse osmosis/filtration systems, and distillation/separation processes. In another aspect, the CULSCI may be included in applications such as industrial water treatment, automotive fluids, metalworking fluids, de-icing compounds, lubricants, cleaners, direct treatment, circuit boards, and inks and coating products. In an aspect, the CULSCI is introduced to an industrial cooling system or an engine cooling system.

A CULSCI may be introduced to an aqueous system in amounts effective to facilitate some user and/or process targeted activity (e.g., corrosion inhibition). For example, to effectively inhibit corrosion, the CULSCI may have to be present above a certain concentration. The minimum inhibitor level required to prevent scale deposition is commonly referred to as “minimum inhibitory concentration” (MIC) or “minimum effective concentration” (MEC). In one or more aspects, a system having an CULSCI introduced may be monitored to ensure the amount of the CULSCI retains some MIC or MEC for that particular system.

Aqueous systems to which the CULSCI may be introduced can further comprise calcium ions, magnesium ions, or both. In one or more aspects, soluble copper may be present in the industrial water in amounts ranging from about 0.01 mg/L to about 10 mg/L, for example, at least about 0.01 mg/L, at least about 0.05 mg/L, at least about 0.1 mg/L, at least about 0.5 mg/L, at least about 1.0 mg/L, or at least about 5.0 mg/L. In another aspect, the industrial water further comprises a halide.

In an aspect, the CULSCI is introduced to a system using any suitable methodology such as being injected into an appropriate input of the system, such as at a port or valve that allows the CULSCI to contact the aqueous system and function to inhibit corrosion. In an aspect, a method of the present disclosure further comprises monitoring and adjusting the CULSCI level to maintain a level of functionality in some user and/or process desired range. In an aspect, an CULSCI of the type disclosed herein may be introduced to a system manually. In an alternative aspect, the CULSCI introduction may be automated. A method may be developed to monitor the concentration of CULSCI in a system. Monitoring of the CULSCI dosage in a system may be continuous, semi-continuous, discrete, automated, manual, or combinations thereof.

In some aspects, the method can be programmed into a device such as a pump to deliver an amount of the CULSCI that results in some predefined dose that is at least the MIC or MEC for that particular system. The method may be automated by use of any suitable supply device such as a material feeder or pump such as a programmable pump.

The device such as a pump can be programmed to operate at specific times for specific run time intervals to add maintenance doses of asci to the volume of water undergoing treatment.

In an aspect, the CULSCIs of the present disclosure surprisingly display increased CUL corrosion inhibition when compared to use of a primary corrosion inhibitor (e.g., triazole) alone. For example, the CULSCIs display an unexpectedly beneficial increase in corrosion inhibition of from about 10% to about 100%, additionally or alternatively, from about 70% to about 90%, or additionally or alternatively, from about 90% to about 99% when compared to the corrosion inhibition observed with the primary corrosion inhibitor alone.

In some aspects, a synergistic effect is observed when the CULSCI is utilized in conjunction with a primary corrosion inhibitor (e.g., a triazole). This may result in a reduction in the minimal concentration of primary corrosion inhibitor needed to effectively address the corrosion issues. In other words, with the addition of an CULSCI of the type disclosed herein, the amount of primary corrosion inhibitor needed to affect the same level of corrosion inhibition may be reduced by equal to or greater than about 10%, additionally or alternatively, equal to or greater than about 15% or equal to or greater than about 20%. The result is a reduction in the use of primary corrosion inhibitors with the concomitant reduction in cost and environmental impact.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

An CULSCI of the type disclosed herein was prepared and evaluated as a corrosion inhibitor. Table 1 provides the test conditions used in the experiment.

TABLE 1
Test Conditions

| Temperature (deg C.) | 32 | |
|---|---|---|
| Water Cut (%) | 100 | |
| Brine | 3% NaCl | |
| Rotation Speed (rpm) | 100 | |
| Coupon Material | Cu | |
| pH | 8 | |
| Time | 48 | hrs. |
| TTA concentration | 8 | ppm |

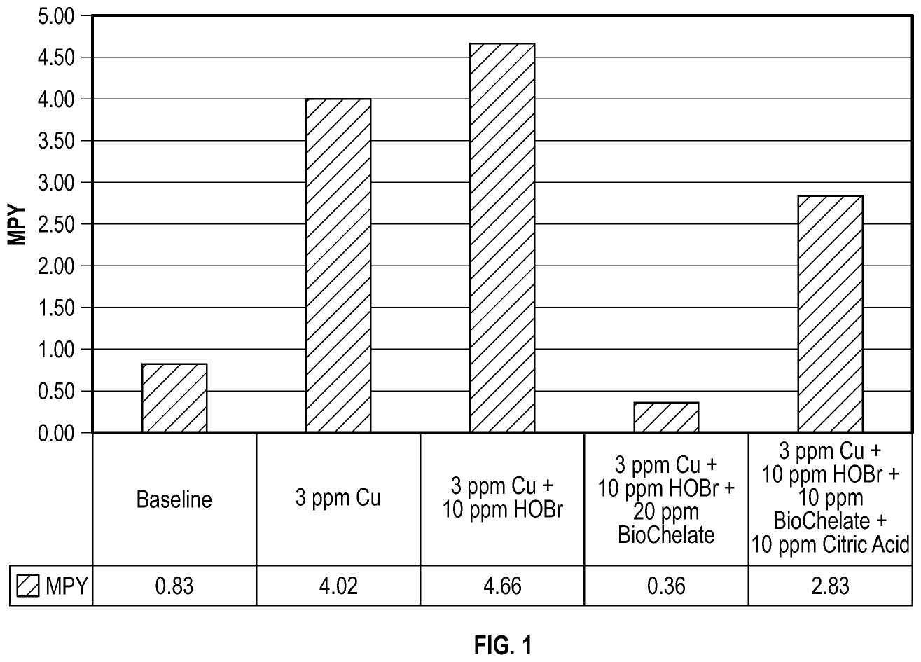

TTA is tolytriazole which was added to the composition in an amount of 8 ppm active. The results are presented in FIG. 1. Referring to FIG. 1, the addition of 3 ppm free copper yielded an increase in the corrosion rate from 0.83 MPY to 4 MPY. The addition of 10 ppm HOBr further increased the corrosion rate to 4.66 MPY. However, as shown in FIG. 1, with the addition of a small amount of Biochelate™ at 20 ppm active leads to the corrosion rate being lower than the baseline. Additionally, and as also shown in FIG. 1, the combination of citric acid and Biochelate™ did not exhibit an increase in performance and, instead, it led to slightly higher corrosion rates. The results of the combination of citric acid and Biochelate™ demonstrates that total concentration of carboxylic acids is not a key indicator of performance, more particularly, because the combination of citric acid and Biochelate™ has a total concentration of 20 ppm active carboxylate as well. Rather, the concentration of Biochelate™ is a key factor in the effectiveness of the CULSCI in reducing corrosion rates.

### Example 2

The amount of TTA was reduced to determine the effect of Biochelate™ on boosting the performance of a conventional CUL inhibitor. The test conditions are presented in Table 2.

TABLE 2
Test Conditions

| | |
|---|---|
| Temperature (deg C.) | 32 |
| Water Cut (%) | 100 |
| Brine | 3% NaCl |
| Coupon Material | Cu |

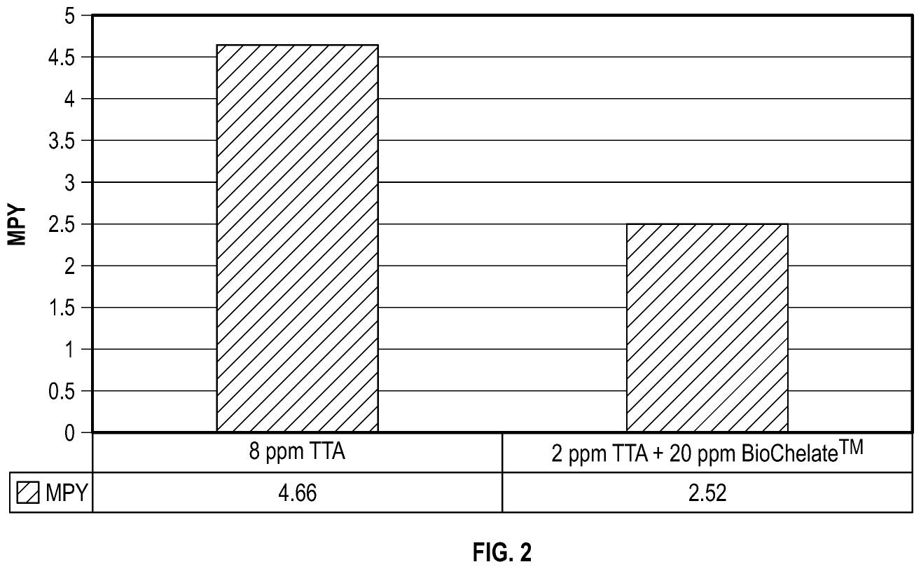

The results are presented in FIG. 2. Referring to FIG. 2, while the TTA concentration is four time (4×) lower, the corrosion rate exhibits a reduction by approximately half. The effect of BIOCHELATE™ in stabilizing the azoles is clearly evident.

### Example 3

A fully formulated product was blended and the effectiveness of the formulated product investigated. The composition of the formulated product was 20% active TTA and 15% active Biochelate™.

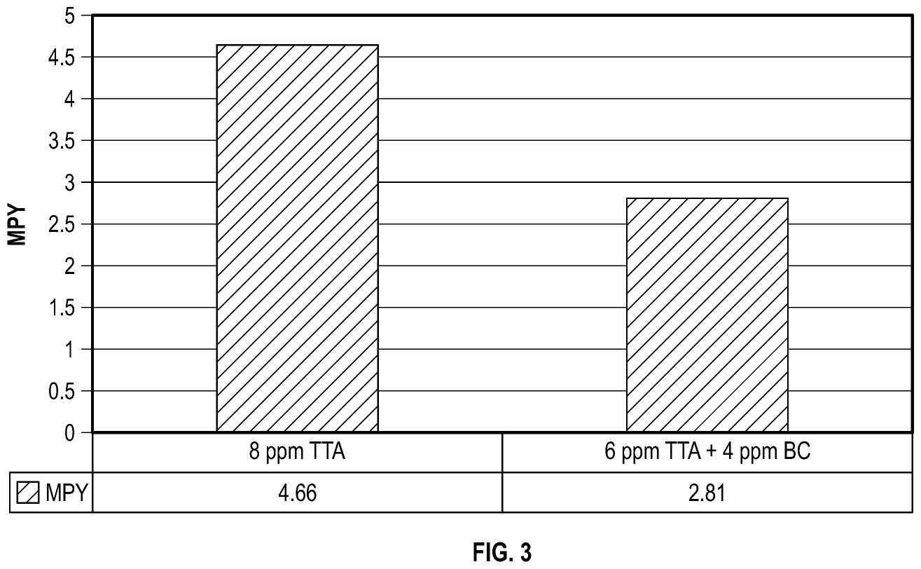

The test conditions were identical to the conditions shown in Error! Reference source not found. The results are presented FIG. 3. Referring to FIG. 3, the formulated Biochelate™-azole product yielded higher performance even though there is less active corrosion inhibitor (as azole) present.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied.

Groups of elements of the periodic table are indicated using the numbering scheme indicated in the version of the periodic table of elements published in Chemical and Engineering News, 63(5), 27, 1985. In some instances a group of elements can be indicated using a common name assigned to the group; for example alkali metals for Group 1 elements, alkaline earth metals for Group 2 elements, transition metals for Group 3-12 elements, and halogens for Group 17 elements, among others.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. While compositions and methods are described in terms of “comprising” various components or steps, the compositions and methods can also “consist essentially of” or “consist of” the various components or steps.

### Additional Disclosure

The following enumerated aspects of the present disclosures are provided as non-limiting examples.

A first aspect is a corrosion inhibitor for a surface comprising copper, brass, other yellow metals, alloys thereof, or combinations thereof, comprising a biochelant, a primary corrosion inhibitor, and a solvent.

A second aspect is the corrosion inhibitor of the first aspect, wherein the biochelant is a naturally-occurring molecule or derived from a monosaccharide or a polysaccharide.

A third aspect is the corrosion inhibitor of one of the first through the second aspects, wherein the biochelant comprises aldonic acid, uronic acid, aldaric acid, a salt thereof, a derivative thereof, or combinations thereof.

A fourth aspect is the corrosion inhibitor of one of the first through the third aspects, wherein the biochelant comprises sodium gluconate, an oxidation product of sodium glucarate, one or more salts thereof, one or more derivatives thereof, or combinations thereof.

A fifth aspect is the corrosion inhibitor of the fourth aspect, wherein the biochelant further comprises n-keto acids and C2-C6 diacids in amounts of less than about 50 wt. %.

A sixth aspect is the corrosion inhibitor of one of the first through the fifth aspects, wherein the primary corrosion inhibitor comprises a thiazole, a triazole or combinations thereof.

A seventh aspect is the corrosion inhibitor of one of the first through the sixth aspects, wherein the primary corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazole, tolytriazole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, derivatives thereof, or combinations thereof.

An eighth aspect is the corrosion inhibitor of claim 1, wherein the solvent comprises ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or combinations thereof.

A ninth aspect is the corrosion inhibitor of one of the first through the eighth aspects, wherein the solvent comprises methanol, ethanol, propanol, isopropanol, n-butanol, isobutanol, pentanol, hexanol, heptanol, octanol, benzyl alcohol, phenol, cyclohexanol, and the like, and combinations thereof.

A tenth aspect is the corrosion inhibitor of one of the first through the ninth aspects, wherein the biochelant is a mixture of aldaric, uronic acids.

An eleventh aspect is the corrosion inhibitor of one of the first through the tenth aspects, wherein the biochelant is a mixture of aldaric acid, uronic acid, and their respective counter-cation.

A twelfth aspect is the corrosion inhibitor of one of the first through the eleventh aspects, wherein the biochelant comprises glucaric acid, gluconic acid, glucuronic acid, glucose oxidation products, and gluconic acid oxidation products.

A thirteenth aspect is the corrosion inhibitor of one of the first through the twelfth aspects, wherein the biochelant comprises sugar oxidation products comprising disaccharides, oxidized disaccharides, uronic acid, and aldaric acid.

A fourteenth aspect is the corrosion inhibitor of one of the first through the thirteenth aspects, wherein the biochelant comprises gluconic acid, glucaric acid, glucuronic acid, n-keto-acids and C2-C6 diacids.

A fifteenth aspect is the corrosion inhibitor of one of the first through the fourteenth aspects, wherein the biochelant further comprises a counter-cation, wherein the counter-cation comprises an alkali earth metal of group 1 and group 2.

A sixteenth aspect is the corrosion inhibitor of one of the first through the fifteenth aspects, wherein the biochelant further comprises a counter-cation, wherein the counter-cation comprises a rare earth metal.

A seventeenth aspect is the corrosion inhibitor of one of the first through the sixteenth aspects, wherein the biochelant further comprises a counter-cation, wherein the counter-cation comprises ammonium.

An eighteenth method for reducing corrosion in a system comprising copper, brass, other yellow metals, alloys thereof, or combinations thereof, the method comprising:
introducing an aqueous solution comprising the corrosion inhibitor of claim 1.

A nineteenth aspect is the method of the eighteenth, wherein the system comprises industrial or source water.

A twentieth aspect is the method of one of the eighteenth through the nineteenth aspects, wherein the industrial or source water further comprises soluble copper, halides or both.

A twenty-first aspect is the method of one of the eighteenth through the twentieth aspects, wherein the dosage of inhibitor is adjustable by manual or automated means in response to manual or automated chemical analysis of the free or complexed soluble copper residual of the industrial or source water.

A twenty-second aspect is the method of one of the eighteenth through the twenty-first aspects, wherein the soluble copper content of the industrial or source water is greater than 0.05 mg/l.

A twenty-third aspect is the method of one of the eighteenth through the twenty-second aspects, wherein the soluble copper content of the industrial or source water is greater than 0.1 mg/l.

A twenty-fourth aspect is the method of one of the eighteenth through the twenty-third aspects, wherein the soluble copper content of the industrial or source water is greater than 0.5 mg/l.

A twenty-fifth aspect is the method of one of the eighteenth through the twenty-fourth aspects, wherein the soluble copper content of the industrial or source water is greater than 1.0 mg/l.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A corrosion inhibitor for a surface comprising copper or alloys thereof, the corrosion inhibitor comprising:
a biochelant;
a primary corrosion inhibitor; and
a solvent.

2. The corrosion inhibitor of claim 1, wherein the biochelant is a naturally-occurring molecule or derived from a monosaccharide or a polysaccharide.

3. The corrosion inhibitor of claim 1, wherein the biochelant comprises aldonic acid, uronic acid, aldaric acid, a salt thereof, a derivative thereof, or combinations thereof.

4. The corrosion inhibitor of claim 1, wherein the biochelant comprises sodium gluconate, an oxidation product of sodium glucarate, one or more salts thereof, one or more derivatives thereof, or combinations thereof.

5. The corrosion inhibitor of claim 4, wherein the biochelant further comprises n-keto acids and C₂-C₆ diacids in amounts of less than about 50 wt. %.

6. The corrosion inhibitor of claim 1, wherein the primary corrosion inhibitor comprises a thiazole, a triazole or combinations thereof.

7. The corrosion inhibitor of claim 1, wherein the primary corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazole, tolytriazole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, derivatives thereof, or combinations thereof.

8. The corrosion inhibitor of claim 1, wherein the solvent comprises ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or combinations thereof.

9. The corrosion inhibitor of claim 1, wherein the solvent comprises methanol, ethanol, propanol, isopropanol, n-butanol, isobutanol, pentanol, hexanol, heptanol, octanol, benzyl alcohol, phenol, cyclohexanol, and combinations thereof.

10. The corrosion inhibitor of claim 1, wherein the biochelant is a mixture of aldaric, uronic acids.

11. The corrosion inhibitor of claim 1, wherein the biochelant is a mixture of aldaric acid, uronic acid, and their respective counter-cation.

12. The corrosion inhibitor of claim 1, wherein the biochelant comprises glucaric acid, gluconic acid, glucuronic acid, glucose oxidation products, and gluconic acid oxidation products.

13. The corrosion inhibitor of claim 1, wherein the biochelant comprises sugar oxidation products comprising disaccharides, oxidized disaccharides, uronic acid, and aldaric acid.

14. The corrosion inhibitor of claim 1, wherein the biochelant comprises gluconic acid, glucaric acid, glucuronic acid, n-keto-acids and C₂-C₆ diacids.

15. The corrosion inhibitor of claim 1, wherein the biochelant further comprises a counter-cation, wherein the counter-cation comprises an alkali earth metal of group 1 and group 2.

16. The corrosion inhibitor of claim 1, wherein the biochelant further comprises a counter-cation, wherein the counter-cation comprises a rare earth metal.

17. The corrosion inhibitor of claim 1, wherein the biochelant further comprises a counter-cation, wherein the counter-cation comprises ammonium.

18. A method for reducing corrosion in a system comprising copper, brass, other yellow metals, alloys thereof, or combinations thereof, the method comprising:
introducing an aqueous solution comprising the corrosion inhibitor of claim 1.

19. The method of claim 18, wherein the system comprises industrial or source water.

20. The method of claim 19, wherein the industrial or source water further comprises soluble copper, halides or both, wherein the soluble copper content of the industrial or source water is greater than 0.05 mg/l.
